(19) United States
(12) Patent Application Publication
(10) Pub. No.: US 2008/0249938 A1
(43) Pub. Date: Oct. 9, 2008

(54) SYSTEM AND METHOD FOR MERCHANT DISCOVERY AND TRANSFER OF PAYMENT DATA

(75) Inventor: Ryan Fredrick Drake-Stoker, Toronto (CA)

Correspondence Address: OGILVY RENAULT LLP, 1981 MCGILL COLLEGE AVENUE, SUITE 1600, MONTREAL, QC, H3A2Y3, CA

(73) Assignee: CPNI INC., Toronto, ON (CA)

(21) Appl. No.: 12/059,419

(22) Filed: Mar. 31, 2008

Related U.S. Application Data
(60) Provisional application No. 60/907,483, filed on Apr. 3, 2007.

(51) Int. Cl. G06Q 20/00; H04L 9/32

(52) U.S. Cl. 705/44; 726/2

(57) ABSTRACT

A method and system are provided for communicating with a merchant server and transferring payment data in a transaction between a mobile device and a merchant server. A user of the mobile device has a user identifier registered with the system and the merchant server has a merchant identifier registered with the system. The method comprises the steps of: receiving the merchant identifier from the mobile device; determining a merchant server address associated with the merchant identifier; establishing a communication channel with the merchant server; exchanging interactive information requests and responses between the merchant server and the mobile device; determining payment data associated with the user identifier; and providing the payment data to the merchant server.

### CROSS-REFERENCE TO RELATED APPLICATIONS

This application claims priority to U.S. Provisional Application No. 60/907,483, filed Apr. 3, 2007, which is hereby incorporated by reference in its entirety.

### TECHNICAL FIELD

This application relates to transactions systems. In particular, this application relates to a system and method for merchant discovery and transfer of payment data in a transaction between a mobile device and a merchant server.

### BACKGROUND

Past attempts to introduce consumers to remote purchases using mobile devices have mimicked online merchant offerings (i.e., e-commerce). The connective nature of the mobile device and the emergence of more interactive applications and platforms such as the Wireless Application Protocol (WAP) make such devices well suited for remote payments and transactions. Making such purchases through mobile devices has become known as m-commerce. However, typical mobile devices have relatively small screen sizes, low bandwidth connections and input devices not designed for the quick entry of large amounts of data, and thus have problems with catalogue-based browsing experiences, such as those found in e-commerce. This has been one challenge to m-commerce.

Another challenge facing m-commerce has been the problem of locating the correct server for connecting to the desired merchant, known as the process of merchant discovery. Mobile devices typically have small and cramped keyboards, resulting in practical limitations on data entry capabilities. Thus, entering the merchant's website or navigating search portals to find the merchant is often frustrating and time consuming.

Another challenge is the need for some degree of interaction between the user and the merchant. This may be as simple as allowing the user to select from a list of choices that the merchant wishes to provide to the user. One current system is the single merchant solution that provides either a short message service (SMS) or mobile application interface. With such a solution, each merchant has a different interface and interaction between the merchant and the user requires finding out how each merchant is providing its service and adapting the interface to the mobile device as part of the merchant discovery process.

It is desirable to provide an m-commerce solution that provides easy data entry and navigation, easy merchant discovery, and a degree of interaction between the merchant and the user.

U.S. Patent Application No. 2007/0042764 teaches a telephone system for subscribers. However, there is no teaching of merchant discovery or secure transfer of payment data without the user needing to enter cumbersome amounts of data.

Thus, there is a need for an m-commerce solution whereby a merchant is able to capitalize on pre-existing e-commerce infrastructure permitting the delivery of service in formats acceptable to various types of mobile devices. There is a need for a solution in which the user does not need to enter long merchant details or cumbersome amounts of payment data which is less secure and more error prone.

### SUMMARY

A system and method for communicating with a merchant server and transferring payment data in a transaction between a mobile device and a merchant server are described.

In some embodiments, the system and method use the device and merchant phone numbers for identification. In some embodiments, the payment data being transferred is credit card data for a credit card transaction.

In some embodiments, the system comprises a mobile application for use on the mobile device to access a mobile server, which communicates with a mobile device gateway server. The mobile application provides a user interface for a user to access the system. The mobile application may provide an identifier for identifying the mobile device and the user.

In accordance with one aspect of the present application, there is provided a system for communicating with a merchant server and transferring payment data in a transaction between a mobile device and a merchant server. A user of the mobile device has a user identifier registered with the system and the merchant server has a merchant identifier registered with the system. The system comprises a mobile device gateway server having a processor operatively connected to a memory. The memory has data and instructions stored therein to configure the mobile device gateway server to interface with the mobile device and to interface with other components of the system to: receive the merchant identifier from the mobile device; determine a merchant server address associated with the merchant identifier; establish a communication channel with the merchant server; send an interactive information request from the merchant server to the mobile device; send an information request response from the mobile device to the merchant server; send a transfer of payment data request from the merchant server to the mobile device; send a payment request response from the mobile device to the merchant server; determine payment data associated with the user identifier; and provide the payment data to the merchant server.

In accordance with another aspect, there is provided a method for communicating with a merchant server and transferring payment data in a transaction between a mobile device and a merchant server. A user of the mobile device has a registered user identifier and the merchant has a registered merchant identifier. The method comprises: receiving the merchant identifier from the mobile device; determining a merchant server address associated with the merchant identifier; establishing a communication channel with the merchant server; sending an interactive information request from the merchant server to the mobile device; sending an information request response from the mobile device to the merchant server; sending a transfer of payment data request from the merchant server to the mobile device; sending a payment request response from the mobile device to the merchant server; determining payment data associated with the user identifier; and providing the payment data to the merchant server.

In accordance with another aspect, there is provided a method of registering a user in a payment system. The payment system is for communicating with a merchant server and transferring payment data in a transaction between a mobile device and the merchant server. The method comprises receiving a request for registration of an account; receiving payment data associated with the user; generating an account identification (ID) and mapping the account ID to the payment data; and storing the account ID, the mapping and the associated data in a database.

These and other aspects and features of the application will become apparent to persons of ordinary skill in the art upon review of the following detailed description, taken in combination with the appended drawings.

### BRIEF DESCRIPTION OF THE DRAWINGS

FIG. 1 is a schematic diagram illustrating a system for merchant discovery and transfer of payment data in accordance with one embodiment of the present application;

FIG. 2A is a flowchart illustrating a process for merchant discovery in accordance with one embodiment of the present application;

FIG. 2B is an example of a user interface for the process of FIG. 2A;

FIG. 3A is a flowchart illustrating a process for user/merchant interaction in accordance with one embodiment of the present application;

FIG. 3B is an example of a user interface for the process of FIG. 3A;

FIG. 4A is a flowchart illustrating a process for payment data transfer in accordance with one embodiment of the application;

FIG. 4B is an example of a user interface for the process of FIG. 4A;

FIG. 5 is a flowchart illustrating a process for registration of a new user in accordance with one embodiment of the application;

FIG. 6A is a flowchart illustrating a process for activation of a new account in accordance with one embodiment of the application;

FIG. 6B is an example of a user interface for the process of FIG. 6A; and

FIG. 7 is a schematic diagram illustrating a computing device that may be used in the system shown in FIG. 1.

It will be noted that throughout the appended drawings, like features are identified by like reference numerals.

### DETAILED DESCRIPTION OF THE PREFERRED EMBODIMENTS

The present application relates to the Applicant's U.S. patent application Ser. No. 11/668,665, which is hereby incorporated by reference in its entirety. The system and method described by the present application share many components with the system and method described in the Applicant's pending application Ser. No. 11/668,665. While many components of the underlying system are described below, it will be understood by those skilled in the art that not all the components described are necessary to practice the methods described below.

The present application provides a system and method that addresses the challenges of m-commerce discussed above and aims to provide a system and method for merchant discovery, user/merchant interaction, and delivery and/or transfer of payment data. The system and method allow a user to carry out transactions with a merchant through a mobile device without having to enter cumbersome data, such as the merchant's address or the user's credit card details.

In one embodiment, the present application provides a system and method of merchant discovery via a single platform in a manner that is consistent with human-computer interaction (HCI) factors encompassing mobile devices.

In one embodiment, the present application also provides a system and method for carrying out transactions through mobile devices that allows for interactivity between the user and the merchant. The system and method provides for interaction with different merchants on a single platform, while catering to each merchant's individual requirements. In order to satisfy the informational requirements of a variety of different merchants, the present application provides a process by which questions may be asked by the merchant and by which the user may either provide a specific response or choose from a range of options. This interface allows the user and merchant to conduct a conversational dialog to determine all information needed to conduct the transaction in a short and efficient manner with consideration given to the practical limitations of a typical mobile device.

In one embodiment, the present application provides a system for identifying a remote merchant, interacting with the user, and finalizing the sale of a product or service through coordination with a payment service.

In one embodiment, the system is used with a pre-existing payment service, so that the merchant does not need to make burdensome changes to its operations.

The following detailed description of the embodiments of the present application does not limit the implementation of the application to any particular computer programming language. The present application may be implemented in any computer programming language provided that the operating system (OS) provides the facilities that may support the requirements of the present application. An embodiment is implemented in the Java™ computer programming language or other computer programming languages such as C or C++ (Java and all Java-based trade-marks are the trade-marks of Sun Microsystems Corporation). Any limitations presented would be a result of a particular type of operating system or computer programming language and would not be a limitation of the present application.

Although the detailed description refers to the use of credit card data for carrying out the m-commerce transaction, any other suitable payment system may be used, such as debit cards, prepaid cards, various systems of merchant points provided by merchants as payment options, or any other remotely identifiable payment mechanism.

### System Architecture

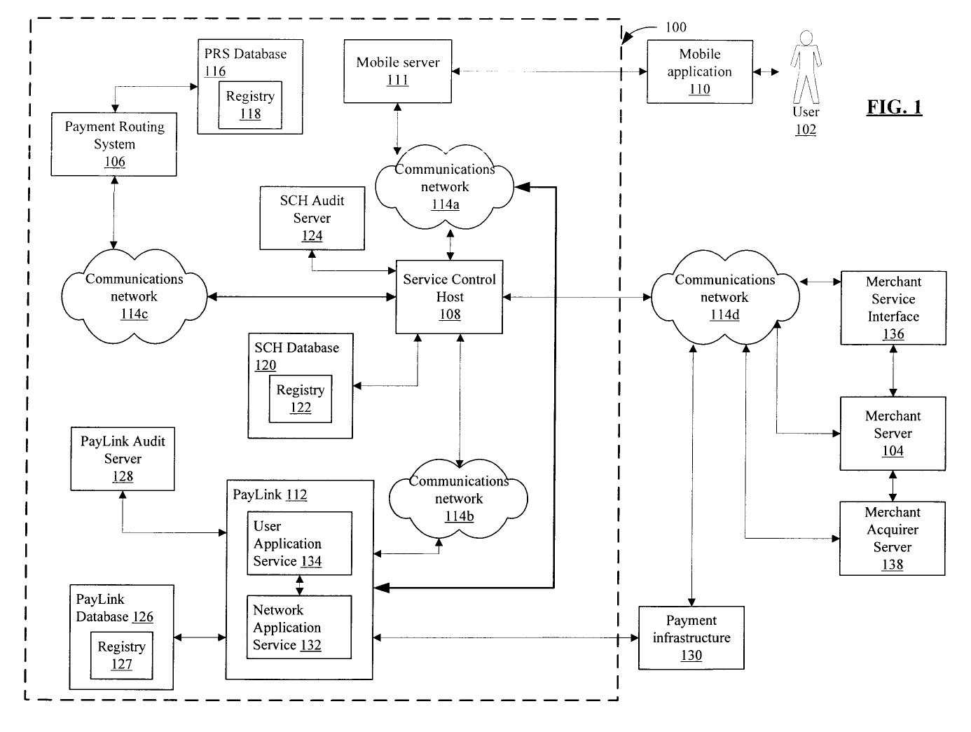

Reference is made to FIG. 1, which shows a schematic diagram illustrating a system 100 for authorizing transfer of payment data in accordance with one embodiment of the present application. In one embodiment, the system 100 may be part of a phone authorized transfer (P.A.T.) system described in the Applicant's pending U.S. application Ser. No. 11/668,665.

This system allows for m-commerce transactions between a user 102 and a merchant server 104. The system 100 comprises a payment routing system (PRS) 106, a service control host (SCH) 108, a mobile server 111, and a PayLink 112. Communication between the PRS 106, the SCH 108, the mobile server 111, the PayLink 112, and the merchant server 104 may take place through a suitable communication network 114a-d, individually indicated as 114a, 114b, 114c, 114d. The system components are described in detail in the respective sections below. The two connections shown in FIG. 1 between the communications network 114a and the service control host 108 and between the communications network 114a and the PayLink 112 represent alternative embodiments. In one embodiment, the mobile server 111 communicates directly with the service control host 108 via the communications network 114a, while in a second embodiment, the mobile server 111 communicates directly with the PayLink 112 through the communications network 114a. More details are described in connection with these two embodiments below.

The communication network 114a-d may be the same network or different networks between each component, and may comprise the Internet (e.g., TCP/IP networking), Wireless Fidelity (Wi-Fi) networks, telephony communications, radio communications, a proprietary interface or connection, or other types of networks. The configuration and/or capabilities of the communication networks 114a-d are not intended to be a limitation of the present application.

### The Payment Routing System

The payment routing system (PRS) 106 provides location information (e.g., merchant server address mappings) for a given merchant or user identifier. The PRS 106 provides an easy and simple way for the user 102 to locate the desired merchant server 104 using a simple identifier, such as a phone number. In one embodiment, the identifier is in pre-existing use, and the user 102 does not need to remember a long identifier or enter a cumbersome address. The PRS 106 provides a process for resolving a unique merchant identifier to the location of the merchant server 104. In one embodiment, the PRS 106 also provides a process for resolving a user identifier to the location of a user account for a mobile merchant transaction or as described in previously mentioned U.S. patent application Ser. No. 11/668,665 for person to person fund transfer.

The SCH 108 may query the PRS 106 in order to locate a merchant server 104. The PRS 106 informs the SCH 108 which merchant server 104 to communicate with based on the merchant identifier provided by the SCH 108. In some embodiments, the PRS 106 includes a database 116 comprising an account table or registry 118 comprising a merchant identifier to merchant server 104 mapping for routing communications between the SCH 108 and the merchant server 104. While a single SCH 108 and a single merchant server 104 is shown, the PRS 106 may be associated with multiple SCHs 108 and provide mappings for multiple merchant servers 104. The mapping of a merchant identifier to the merchant server 104 may be created when the merchant server 104 is first registered with the system 100. Merchant registration takes place through a process that directly updates the mapping of the merchant identifier and the merchant address at the PRS database 116.

In one embodiment, the PRS 106 is maintained by a service provider and is designed with compliance to international privacy and security standards, open architecture standards, platform flexibility and scalability, physical and logical security standards and universally adopted norms. In addition to allowing the SCH 108 to locate a merchant server 104, the PRS 106 may also allow multiple SCHs 108 to locate each other.

### The Service Control Host

In one embodiment, the service control host (SCH) 108 provides a mobile device gateway server for managing (i.e., receiving, processing, sending, etc.) the data transfer and interaction (i.e., merchant scripting, payment request, confirmation, etc.) between the user 102 using the mobile server 111 and the merchant server 104. The SCH 108 is responsible for managing and/or controlling the interaction between the merchant server 104 and the PayLink 112, and between the mobile server 111 and the PayLink 112. While a single PayLink 112 is shown, the SCH 108 may be associated with multiple PayLinks 112. Typically, each SCH 108 manages an application gateway within one country for the PayLinks 112 within that country, however the SCH 108 may manage an application gateway for multiple countries or regions.

In one embodiment, the SCH 108 receives and processes incoming requests to the system 100 from the mobile server 111. The SCH 108 implements an application gateway that performs one or more of the following functions: (1) route data between the PayLink 112 and the merchant server 104; (2) receive and process registration requests from the PayLink 112 and store user information (including PayLink account ID) in association with a user identifier (ID); (3) query or look-up address information of the destination merchant server 104; and (4) communicate with other SCHs 108.

The SCH 108 is connected to a SCH database 120 having a registry 122 mapping user IDs to PayLink account IDs. However, no payment data is stored in the SCH database 120. The user ID is at least unique to that SCH 108 and the PRS 106 associated with that SCH 108, though the user ID may also be unique across multiple SCHs 108. The unique user ID may also be referred to as a user identifier.

The SCH 108 may also comprise a services server (not shown) for providing service and/or a World Wide Web (WWW or Web) administration server for providing a Web interface for the administration of the SCH 108. The Web administration server module is a web application used by a user 102, in particular an administrator, to query and view the past transactions and also provides the following functions: (a) adding a new financial institution; and (b) changing territory partner configuration. Adding a new financial institution to the system includes the ability to add or remove a node and/or host, which may be done in concert with other administrators. Changing territory partner configuration includes changing the configuration for components related to that territory partner.

The SCH database 120 and the Web administration server aspects of the SCH 108 may be implemented as software modules running on the SCH 108, or as a plurality of interconnected servers (not shown) each running one or more of the software modules responsible for implementing these services.

In one embodiment, the SCH 108 also provides for services such as user registration and account activation. The SCH 108 may also check the authenticity of the user based on the user identifier and/or an authentication personal identification number (PIN). The SCH 108 may also have an email or SMS notification interface module that makes use of existing email/SMS services and initiates event-based messages to the mobile server 111 using these services.

In one embodiment, the SCH 108 is connected to an independent SCH audit server 124. The SCH audit server 124 is outside of the SCH 108 and logs the transaction data relevant to the corresponding SCH 108. Typically, no sensitive information such as bank account numbers, credit card number, or passwords is logged. Alternatively, this function may be performed by an audit module within the SCH 108.

While a number of functions have been described in connection with the Service Control Host 108, it is to be understood that many of these functions are equally applicable to the PayLink 112 in the embodiment where the mobile server 111 communicates directly with the PayLink 112 (i.e., as opposed to the Service Control Host 108) through the communications network 114a. In particular, in the embodiment where the mobile server 111 communicates directly with the PayLink 112, the PayLink 112 facilitates many of the functions that relate directly to the mobile application 110 or the mobile server 111, such as user registration and account activation. For example, the PayLink 112 may also check the authenticity of the user based on the user identifier and/or an authentication personal identification number (PIN). The PayLink 112 may also have an email or SMS notification interface module that makes use of existing email/SMS services and initiates event-based messages to the mobile server 111 using these services.

### The Mobile Server

The user 102 may access the system through a mobile device, for example a mobile phone or a personal digital assistant (PDA). The mobile device accesses the system 100 through a mobile server 111, and a mobile application 110 downloaded onto the mobile device may be used by the user to interface with the system 100. The mobile application 110 may be a Java Micro Edition (ME) MIDlet, usable on a large percentage of mobile devices in which case the mobile server 111 is a MIDlet server and the mobile application 110 is referred to as a MIDlet service, or some other suitable, downloadable mobile device application. A MIDlet is one type of software application that may be downloaded onto mobile devices to provide additional functionality. Other possible platforms for the mobile application 110 include the Wireless Internet Platform for Interoperability (WIPI), the Binary Runtime Environment for Wireless (BREW), Symbian, Python, Flash Lite, and PalmOS.

Other interface options for the user 102 to interact with the system 100 include online banking portals, SMS, WAP, and IVR (interactive voice response). SMS is a function that is available on most digital mobile phones that allows for sending and receiving of short text messages between mobile phones. IVR is a computerized system that allows a person, typically a telephone caller, to select options from a voice menu and otherwise interact with the computer phone system, usually through pre-recorded voice prompts. WAP is an open international standard for applications that use wireless communication that enable access to the Internet from a mobile device. Not all user interfaces may be suitable to provide the entire array of functionality that the system 100 is intended to offer, and different financial institutions may prefer different interfaces. For example, Java applications on Java-enabled mobile devices offer functional advantages over other interfaces and are compatible with a majority of mobile devices currently in use. Alternatively, a combination of SMS and IVR offers security and convenience, as well as compatibility with almost every mobile device currently in use. Regardless of the specific mobile device interface chosen, interactions with the system 100 are not affected. In one embodiment, the user 102 may bypass the mobile server 111, for example where the user 102 connects with the SCH 108 directly. In another embodiment, the user 102 may connect with the PayLink 112 directly. In one embodiment, the user 102 interfaces with the system 100 through the mobile server 111, using the mobile application 110. Although the following description is in relation to a mobile application 110 used on a mobile device, it should be understood that other interfaces may be used that may provide similar functions.

Interactions initiated, managed or controlled by the mobile server 111 include: (1) communication with the SCH 108, in one embodiment, or communication with the PayLink 112, in the second embodiment; (2) account activation; and (3) communication with the merchant server 104. The mobile application 110 and the mobile server 111 provide a secure means of interaction between the user 102 and the system 100. The user 102 may be identified to the system 100 through the mobile application 110, for example the mobile application 110 may be associated with a unique encrypted security certificate that is traded in order to establish a secure communication channel and which may also be used to identify the mobile application 110. The mobile application 110 may be identified by the mobile server 111, and this identification may be passed to the SCH 108 or the PayLink 112. The user 102 may be required to login to the mobile application 110 using a unique user name and password, which may be used to identify the user 102. The user ID may be associated with the mobile device having the mobile application 110, so that a user 102 having multiple mobile devices would have different user IDs for each mobile device, or the user ID may be associated with the user 102, so that a user 102 having multiple mobile devices would carry the same user ID across all the devices. Although the user 102 may be identified through any of the methods described, further authentication of the user 102, for example by entering a PIN, may be required.

Each mobile server 111 is managed either by one SCH 108 or by one PayLink 112. While one mobile server 111 is shown, it should be understood that a single SCH 108 or a single PayLink 112 may manage multiple mobile servers 111. While one mobile application 110 is shown, it should be understood that a single mobile server 111 may manage multiple mobile applications 110, and a user 102 may use multiple mobile applications 110 on a single or on multiple mobile devices.

### The Merchant Server

The merchant server 104 is typically located outside of the system 100 and communicates with the user 102 via the SCH 108. A merchant server 104 is identified by a unique merchant identifier, such as a phone number or a domain name, in the PRS database 116 as a merchant record.

The actual user/merchant interface implementation exists as a service at the merchant server 104, typically outside of the system 100, and may be unique to each merchant server 104. Although the merchant server 104 is shown communicating with a single SCH 108, it should be understood that any SCH 108 may access the merchant server 104, provided the supplied credentials and authentication are acceptable to the merchant server 104. In one embodiment, the merchant server 104 and SCH 108 communicate through a merchant service interface 136. However, the merchant server 104 may also be accessed directly through the communication network 114d. The merchant server 104 retains all of the business logic required for an m-commerce transaction and interacts with the SCH 108 over the communication network 114d using, for example, an extensible markup language (XML) interface over a secure hypertext transfer protocol (HTTPS) connection. XML offers useful system integration options and is not dependent on the implementation, which is useful for coordinating interaction among different systems. Although one embodiment uses an XML interface to define a script of interactions between the user 102 and the merchant server 104, any other synchronous way of transmitting a script of interactions may be used.

In one embodiment, the merchant service interface 136 is a public API (application programming interface) implemented on pre-existing billing and/or payment systems and registered in the PRS 106 with appropriate security certificates under the merchant identifier. The merchant service interface 136 provides services for the user 102, for interactions and transactions such as paying bills. The SCH 108 passes user data to the merchant server 104 via the merchant service interface 136 upon authorization by the user 102.

The merchant server 104 may also communicate with a merchant acquirer server 138, in particular where the merchant server 104 carries out transactions using credit cards. The merchant acquirer server 138 is a pre-existing service, such as a web service, typically located outside of the system 100 and is accessible by any service providing the correct credentials. Multiple merchant servers 104 may be registered on a merchant acquirer 138, and the merchant acquirer server 138 manages credit card transactions provided by the merchant server 104. The merchant acquirer server 138 may also interact with the payment infrastructure 130 of a financial institution through the communication network 114d for standard credit card processing, known to those skilled in the art.

### The PayLink

The system 100 interacts with a financial institution through a PayLink 112 associated with that financial institution. In one embodiment, the PayLink 112 communicates with the SCH 108, and is accessed through the SCH 108. In the second embodiment, the PayLink 112 may communicate with the SCH 108, and may be accessed through the SCH 108 or directly by the mobile server 111 through the communications network 114a.

The PayLink 112 is run by the associated financial institution. The PayLink 112 stores personal data and financial and/or payment data for its associated financial institution. The PayLink 112 is entirely within the infrastructure of the financial institution. This increases the protection of sensitive financial and personal data stored by the PayLink 112. Interaction with the PayLink 112 occurs through the SCH 108 associated with that PayLink 112 or directly by the mobile server 111, and access to the data stored on the PayLink 112 is performed by the PayLink 112 itself. Hence, in one embodiment, in order to access data stored in the PayLink 112, an external entity communicates with the SCH 108 which then communicates with the PayLink 112. In the second embodiment, the mobile server 111 may access the PayLink 112 directly. Sensitive data transmitted outside of the PayLink 112 is kept to a minimum and typically does not persist in the system 100 outside of the PayLink 112.

Each user 102 is assigned a PayLink account ID associated with personal data and financial and/or payment data, such as a credit card number. The PayLink account ID is associated with a user 102 by way of a user ID, such as a phone number or a user name. This information is registered in a registry 127 in a PayLink database 126 on the PayLink 112 when the user is first registered. Each PayLink account ID is unique to at least that PayLink 112 and/or the SCH 108 with which that PayLink 112 is connected. Although a single user 102 is shown, it should be understood that multiple users 102 may be registered with the PayLink 112. A single user 102 may be associated with multiple PayLink account IDs, such as where a user 102 has multiple credit cards registered with the system 100. In such a case, multiple financial instruments, such as a credit card or debit card, issued by the same or different financial institutions may be associated with a single PayLink account ID. Typically, a PayLink account ID is only associated with financial instruments issued by the financial institution associated with that PayLink 112.

The PayLink registry 127 associates a user 102 with PayLink account data, which may include customer identification information, bank account information (such as account type, account number, and currency), PayLink account ID, and payment data such as a credit card number. In a payment transaction, the SCH 108 retrieves the user's payment data from the PayLink database 126 of the associated PayLink 112 and passes the payment request confirmation along with payment data to the merchant server 104. For example, where the payment transaction is a credit card transaction, the merchant server 104 may then perform the credit card transaction as if the user 102 had entered his credit card details directly onto a merchant web site, as is known in the art, particularly for e-commerce. This will be further described in the section on Transfer of Payment Data below.

Although a single PayLink 112 is shown, it should be understood that a SCH 108 may be associated with multiple PayLinks 112. In that case, the PayLinks 112 do not communicate directly with each other, but only through the SCH 108. The PayLink 112 is typically associated with a financial institution and provided with security features typical of the financial institution. To protect the sensitive payment data in the PayLink 112, each PayLink 112 is typically associated with a single financial institution, though each financial institution may have a plurality of PayLinks 112.

The PayLink 112, in one embodiment, is connected to an independent PayLink audit server 128 for maintaining and ensuring the integrity of that PayLink 112 and transactions carried via that PayLink 112. Similar to the SCH audit server 124, the PayLink audit server 128 logs the transaction data relevant to the corresponding PayLink 112. Typically, no sensitive information such as bank account numbers, credit card numbers, or passwords is logged. Alternatively, this function may be performed by an audit module within the PayLink 112.

The PayLink 112 may also communicate with the payment infrastructure 130 of the financial institution, for example the card issuing services. This allows the PayLink 112 to be updated whenever a user 102 changes payment data, such as the expiry date of a credit card. Such an update may be done through a process implemented by the financial institution to alter the PayLink database 126, similar to processes for adding or removing a bank account.

The PayLink 112 provides a standardized communications protocol for each financial institution to communicate with the system 100 and for securely connecting the system 100 to the financial institution's internal communications network and infrastructure, thereby providing a first line of security by introducing a degree of separation between the financial institution and the system 100. It should be understood by persons skilled in the art that although the description is given for financial institutions, other entities and institutions may participate in the system 100.

The PayLink 112 is typically associated with a single financial institution and is run entirely within that financial institution. The PayLink 112 has a network application service 132 which manages communication with the SCH 108. In one embodiment, the PayLink 112 is accessed through the SCH 108. In the second embodiment, the PayLink 112 may also be accessed directly by the mobile server 111 through a user application service 134, which manages communication with the mobile server 111. The application services 132, 134 are typically software modules running on the PayLink 112, but may also be implemented as discrete, interconnected servers. Although not shown, the PayLink 112 may also be accessed by pre-existing services provided by the financial institution, such as telephone banking and online banking services. The PayLink 112 may also interact with other pre-existing services in the financial institution, such as merchant acquirer processing services, card issuing services and card transaction authorization services. A person skilled in the art would understand that a financial institution may have more or less services than those listed here that may interact with the PayLink 112. In one embodiment, the PayLink 112 communicates directly with only the SCH 108, and is not directly accessed by any component outside the system 100. In the second embodiment, the PayLink 112 also communicates directly with the mobile server 111.

### System Operation

The system 100 provides account and user management applications for implementing a variety of account and user management functions. User management functions may be performed by users 102 and include changing payment data and changing passwords or personal identification numbers (PINs). Account management functions may be performed by the participating financial institutions and include adding and removing registered bank accounts, adding and removing credit card accounts, and/or updating payment data. The account and user management applications are typically provided as part of a larger application that may be a web-based application accessible from a secure computing terminal, an IVR application, a mobile application 110 accessible from a user's mobile device, or may be implemented by other methods. In order to access the system 100, the user 102 must be registered through a mobile device, which is discussed below in the section on Registration.

A typical transaction using the system 100 comprises aspects of: (1) merchant discovery; (2) user/merchant interaction; and (3) transfer of payment data. While the following description refers to transactions through the mobile server 111 using a mobile application 110 on a mobile device, it should be understood that the same process may be carried out using other interfaces, such as SMS and/or IVR.

### Merchant Discovery

The merchant server 104 is identified using a merchant identifier, such as the merchant's phone number. Using a phone number provides the merchant with a pre-existing identifier that may be already familiar to the user 102 and is unique to the merchant on a global basis. Other possible identifiers include the merchant's domain address.

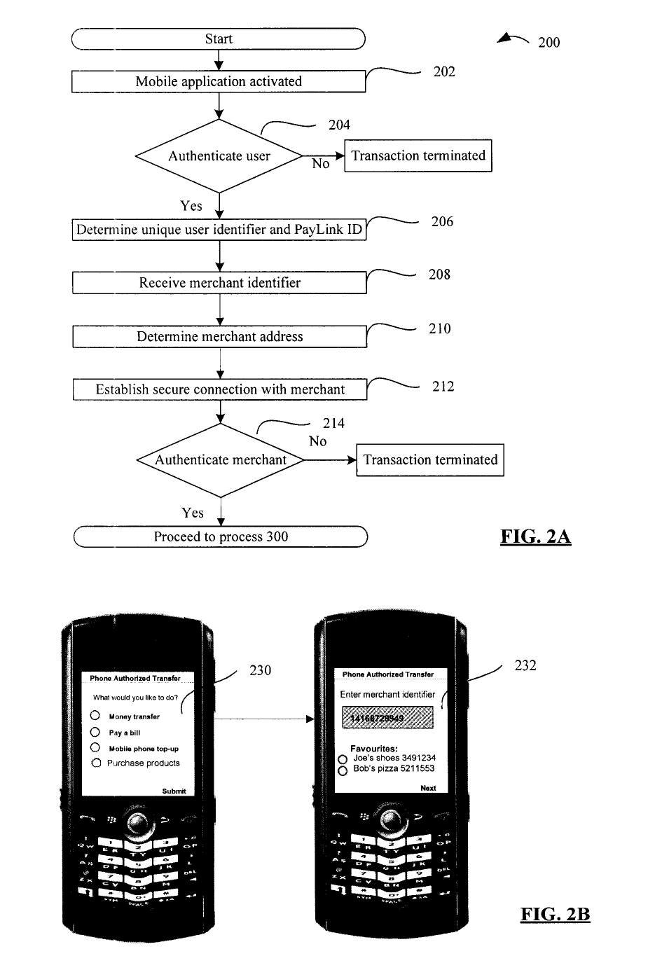

Reference is next made to FIG. 2A, which shows a flowchart illustrating a process 200 for merchant discovery in accordance with one embodiment of the present application.

In a step 202, the user 102 initiates a transaction by accessing the mobile server 111 through the mobile application 110 on the mobile device.

Next, in a step 204, the mobile server 111 requests user authentication from the user 102. This may require the user 102 to enter a PIN. If the correct PIN is entered, the user 102 may continue, otherwise the user 102 may be prompted again to enter a PIN or the process ends. Repeated incorrect PIN entry, for example five times in a row, may cause the user's account to be locked and the user 102 must then contact the associated financial institution to re-activate the account.

Once the user 102 has been authenticated a secure connection is established between the mobile server 111 and the SCH 108 (or, in the second embodiment, between the mobile server 111 and the PayLink 112) over HTTPS or another communication protocol using the transport layer security (TLS) protocol for security. Such a process would be understood by those skilled in the art of secure network communication. The TLS protocol allows applications to securely communicate across a network while preventing eavesdropping, tampering, or message forgery by providing endpoint authentication and communications privacy over the Internet using cryptography. HTTPS is a method of secure interaction over a network, using TLS to secure a hypertext transfer protocol (HTTP) interaction.

Next, the process 200 proceeds to a step 206, where the PayLink account ID is determined by the SCH 108 (or in the second embodiment, by the PayLink 112), based on the user ID, such as the user name provided by the user 102 or some other identifier such as PIN numbers associated with the mobile application 110.

Next, at a step 208, the user 102 provides the merchant identifier to the mobile server 111. This information may be entered by the user 102 using a keypad on the mobile device. The mobile application 110 may also store a list of favourite merchants or frequently accessed merchant servers 104 from which the user 102 may select the desired merchant. The mobile server 111 communicates the merchant identifier to the SCH 108 (or in the second embodiment, to the PayLink 112).

Next, at a step 210, the SCH 108 queries the PRS 106 to identify the merchant server 104 associated with the merchant identifier. This may first require the establishing of a secure connection between the SCH 108 and the PRS 106, using procedures as would be known to those skilled in the art. The PRS 106 returns the address of the merchant server 104 to the SCH 108 using the mapping in the merchant registry 118 of the PRS database 116.

Next, in a step 212, the SCH 108 opens a secure communication channel, such as a HTTPS connection, with the identified merchant server 104 over the communication network 114d. This typically involves exchanging security certificates and encryption keys, as is known in the field of network communication.

Next, at a step 214, the SCH 108 authenticates the merchant server 104. This is done using mutual authentication, in accordance with typical network authentication techniques known to those skilled in the art.

If authentication fails, the user 102 is sent an error message and the transaction is terminated. The SCH 108 communicates with the merchant server 104 through the merchant service interface 136. Thus, the merchant server 104 is buffered from the SCH 108 through the merchant service interface 136, and the SCH 108 does not need to know the precise implementation used by the merchant server 104. In this way, the user/merchant interface does not need to be adapted to the system 100, simplifying the implementation of the merchant server 104 to communicate with the system 100.

Interaction between the user 102 and the merchant server 104 may now take place via the SCH 108 (or in the second embodiment, via the PayLink 112 and the SCH 108), over the established secure communication channel.

Reference is next made to FIG. 2B, which shows an example of the user interface presented on the mobile device to the user 102 for merchant discovery.

In one embodiment, a user interface 230 is presented to the user 102 when the user begins the process 200 at the step 202. The user interface 230 presents a list of common transactions, such as a money transfer, bill payment, mobile phone top-up, product purchase and other online payments.

The user 102 selects a transaction, and at the step 208 is presented with a user interface 232, in which the user can enter a merchant phone number or select a merchant from a list.

### User/Merchant Interaction

User/merchant interaction occurs via the SCH 108 (or in the second embodiment, via the PayLink 112 and the SCH 108). The merchant service interface 136 defines a single flexible service interface for the merchant server 104, simplifying implementation and integration with the system 100. In one embodiment, the interaction is achieved using XML interaction over HTTPS. This method offers certain advantageous integration options and does not need implementation information, an attribute desirable for coordinating the different components in the system 100.

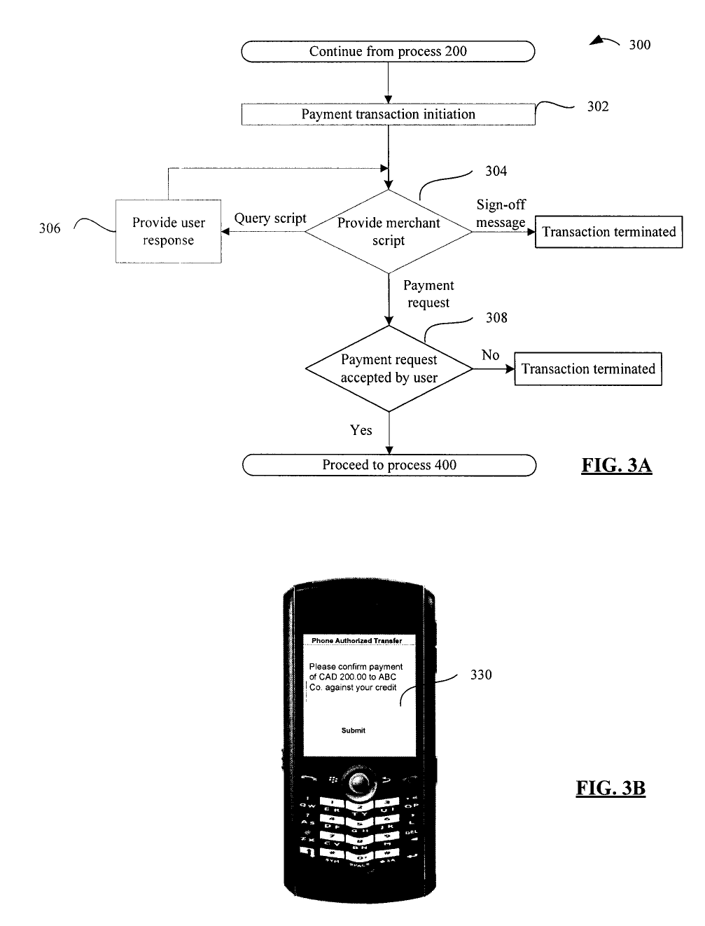

Reference is next made to FIG. 3A, which shows a flowchart illustrating a process 300 for user/merchant interaction in accordance with one embodiment of the present application.

A first step 302 of the process 300 continues from the establishment of a secure communication channel between the SCH 108 and the merchant server 104 as described above in connection with the process 200. At the step 302, the SCH 108 provides a transaction initiation request to the merchant server 104 to initiate the transaction. The request may provide information to identify the user 102, such as a phone number.

Next, at a step 304, the merchant server 104 responds with: (1) an interactive query script, (2) a payment request, or (3) a sign off message. These are all scripts that make up the user/merchant interface and are described in further detail below. In one embodiment, the merchant server 104 responds with a query script to continue the transaction. In one embodiment, the script is achieved using XML interaction between the merchant server 104 and the SCH 108. Typically, the script is an interactive decision tree whereby the user 102 is guided through a set of choices or provided with a set of information to enable a purchase. The script is passed from the merchant server 104 to the mobile server 111 via the SCH 108 (or in the second embodiment, to the mobile server 111 via the SCH 108 and the PayLink 112). The mobile device displays the script in a suitable format appropriate for the mobile device. The user/merchant interface may be simple enough to be usable across different mobile devices but rich enough to obtain the information required to complete the transaction.

If the merchant server 104 responds with a query script, the user 102 provides a user response at a step 306 and the process 300 returns to the step 304.

If the response of the merchant server 104 is a sign off message, this is displayed to the user 102 and the transaction ends.

If the response of the merchant server 104 is a payment request, the process proceeds to a step 308 where the user 102 may accept the payment request. If the user 102 refuses the payment request, the transaction is terminated, or the process may return to an earlier step to refine the transaction. If the user 102 accepts the payment request, transfer of payment data may proceed, as is described in more detail below in the section on transfer of payment data.

The query script from the merchant server 104 may prompt the user 102 for additional information, or some other response. At the completion of the script, the results are sent back to the merchant server 104, via the SCH 108 (or in the second embodiment, via the PayLink 112 and the SCH 108). The merchant server 104 may again respond with: (1) a query script; (2) a sign off message; or (3) a payment request. The sign off response may be a simple text message displayed on the mobile device. The payment request is comprised of a request for authorization for payment and an amount. The amount is displayed to the user 102 and may include an explanatory message provided by the merchant server 104. The user 102 is asked to confirm acceptance to pay. The user 102 may be made aware that the merchant is being authorized to receive the authorized amount, for example by charging the credit card associated with the user's registered PayLink account. This will be described in further detail below in the section on Transfer of Payment Data.

An interactive query script is a simple decision tree passed to the mobile server 111 and presented on the mobile device to the user 102. This script is used to guide the user 102 through a set of choices or provide information to enable the transaction. For example, the user 102 may enter an outstanding bill number the user wishes to pay or choose to purchase movie tickets from a menu. The script comprises a simple set of instructions for information gathering, screen display elements, display data, mappings of values to variables and simple logic to drive the interaction and return the needed data to the merchant server 104 at the correct point in the process.

The query script may comprise a series or a tree of pages. Each page has one or more of the following elements: a text element; a text entry element; and/or a choice selection element. These elements are static rather than dynamic and the navigational relationship between the pages may be determined by the merchant server 104 before the script is sent. Any decisions that are based on the information being submitted that are dynamic are made by the merchant server 104. In one embodiment, each page contains combinations of text elements with text entry boxes or text elements with choice elements, to simplify the user interface on the mobile device. The choice entry may have an additional capability beyond recording the user's choice. The choice entry may provide a navigation menu to another page. In this way, decision trees may be used to identify the user's wishes and selection without requiring constant communication between the mobile server 111 and the merchant server 104. In one embodiment, the script is kept simple to keep device requirements low. There may be a trade-off between the size of a given query script and the number of scripts passed between the mobile server 111 and the merchant server 104, where smaller scripts result in a larger number of scripts being exchanged during the process 300.

Reference is next made to FIG. 3B, which shows an example of the user interface presented to the user 102 during a user/merchant interaction, in accordance with one embodiment of the present application.

A user interface 330 is presented to the user 102 at the step 308, in which the merchant server 104 has requested payment, and the user 102 is provided with the option of entering a payment amount and submitting confirmation of the payment.

### Transfer of Payment Data

The merchant server 104 may provide a payment request to the user 102. This request contains the details of the amount being requested and automatically initiates a confirmation request to the user 102. The result of the confirmation request is passed back to the merchant server 104. In the first embodiment, once confirmation is provided, the SCH 108 requests the payment data associated with the user 102 from the PayLink 112 and passes this with the confirmation through to the merchant server 104. In the second embodiment, the PayLink 112 passes the payment data associated with the user 102 along with the confirmation through the SCH 108 to the merchant server 104. The merchant server 104 may then reply with a sign off response such as an order confirmation number to the user 102.

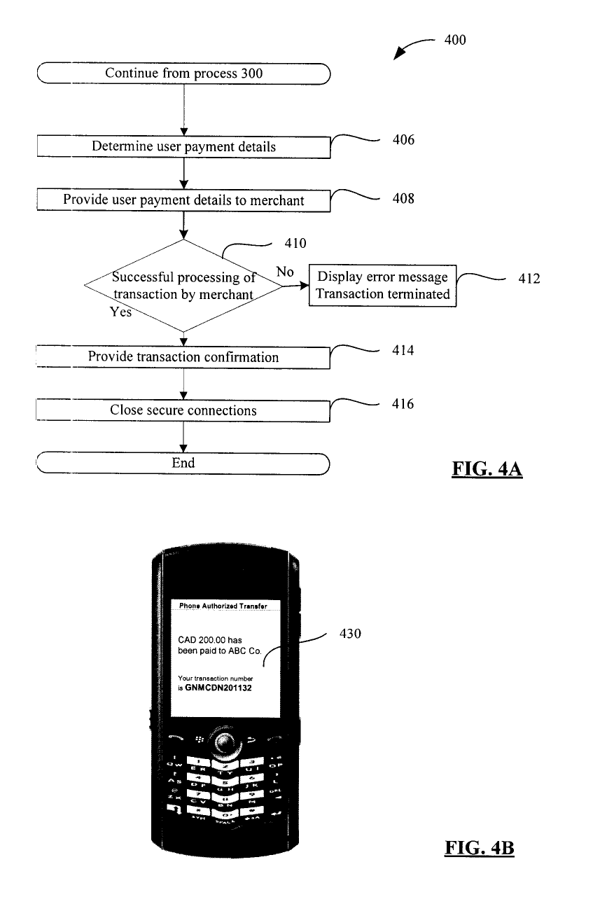

Reference is next made to FIG. 4A, which shows a flow chart illustrating a process 400 for transfer of payment data in accordance with one embodiment of the present application. The process 400 continues from the process 300 shown in FIG. 3A.

After the user 102 accepts the payment request at the step 308 (FIG. 3A), the payment request is returned to the SCH 108 (or in the second embodiment, to the PayLink 112 and then to the SCH 108) at a step 406. In one embodiment, the SCH 108 maps the unique user ID to the user's PayLink account ID using the SCH registry 122. The SCH 108 then contacts the PayLink 112 associated with the PayLink account ID for the user's payment data. In the second embodiment, the PayLink 112 may map the unique user ID to the user's PayLink account ID. The PayLink 112 retrieves the user's payment data from the registry 127 in the PayLink database 126 and returns the payment data to the SCH 108. In one embodiment, communication between the SCH 108 and the PayLink 112 and/or between the PayLink 112 and the mobile server 111 takes place over a secure connection, and may involve the exchange of security certificates and encryption keys as would be known to those skilled in the art.

Next, at a step 408, the SCH 108 passes confirmation of the request along with the payment data to the merchant server 104. Such payment data may be, for example, the user's credit card information.

Next, at a step 410, the merchant server 104 performs a payment transaction, for example a credit card transaction, using payment transaction procedures known to those skilled in the art, similar to online transactions. If the payment transaction is unsuccessful, the merchant server 104 may return an error message, which is displayed to the user 102. The process 400 may then return to an earlier step to retry the transaction, or the transaction may end.

If the transaction is processed successfully, the merchant acknowledges receipt with a confirmation such as an order number at a step 414. The order number is returned to the mobile server 111 and displayed on the mobile device for the user 102 to view.

Next, at a step 416, the process ends and the SCH 108 drops the secure communication channel with the merchant server 104. In one embodiment, the process may continue, allowing further purchases or other options for the user 102, for example by returning to the step 302 of the process 300.

Reference is next made to FIG. 4B, which shows an example of the user interface presented to the user 102 during transfer of payment data, in accordance with one embodiment of the present application.

A user interface 430 is presented to the user 102 at the step 414, providing confirmation that transfer of the payment data was successful and also a transaction order number.

Although not shown in the processes 200, 300, and 400, it will be appreciated by persons ordinarily skilled in the art that there are various checks performed at each step to ensure the user has entered a valid input. For example, if the user is given a choice between pressing 1 and 2 on the wireless device keypad, checks are implemented and enforced to ensure that either 1 or 2 is entered by the user. Typically, if an invalid input is received the user will be prompted to re-enter his or her selection at the respective step until a valid input is obtained or until a preset number of attempts are made.

Although a payment transaction is carried out in the process 400, it will be appreciated by persons skilled in the art that the operations have occurred under the security constraints acceptable to the financial institution. No payment data is persisted in the system 100 outside of the financial institution or its PayLink 112, with the exception of the user's payment data being securely provided to a verified merchant server 104.

### Registration

Although the registration process is described with respect to a user 102, it should be understood that similar steps may be used to register a merchant server 104 on the system 100.

A user 102 may be registered with the system 100 through a trusted party, such as a financial institution or card issuer with an existing user relationship. During the registration process, the user's personal data and payment data are captured and associated with a user identifier, such as a phone number.

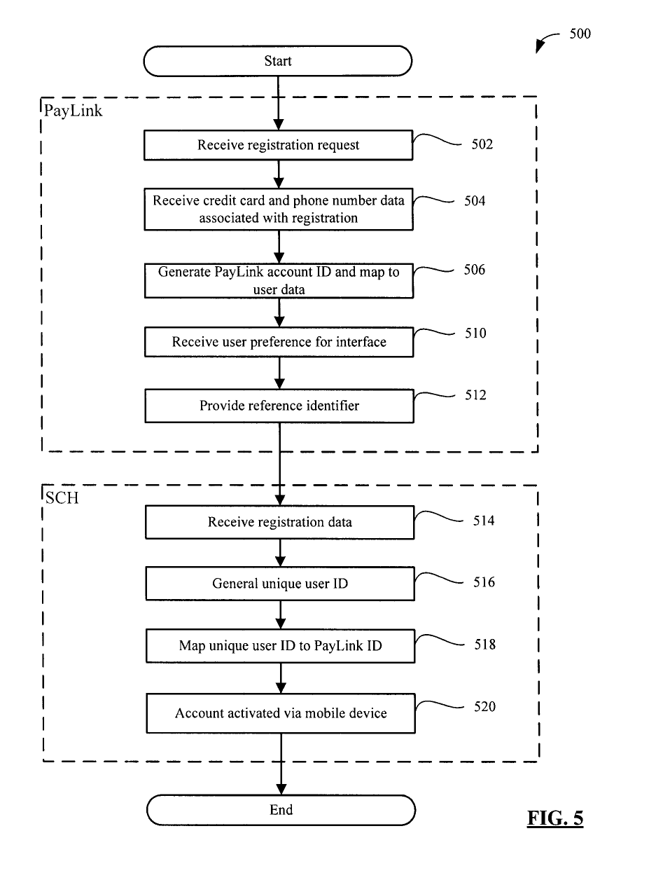

Reference is now made to FIG. 5, which shows a flowchart illustrating a process 500 for registering a new user in accordance with one embodiment of the present application.

At a step 502, the user 102 chooses to register with the system 100. This may be done by the user 102 logging into the PayLink 112 of the user's financial institution. This may also be done by the financial institution, as part of the procedure for opening a new credit card account, for example.

Next, at a step 504, payment data, such as the user's credit card data, is associated with the registration, as well as the user's data and identifier, such as a phone number or user name.

Next, at a step 506, a PayLink account ID is generated and mapped to the data provided in the step 504. This mapping and the associated data are stored in the PayLink database registry 127.

Merchants are registered at the PRS 106 so that PRS database 116 is updated with the mapping of the merchant server address and the merchant identifier.

Next, at a step 510, the user 102 chooses an interface for carrying out transactions. This may be a mobile application 110 for a mobile device or a different application providing SMS and/or IVR-based functionality. This option may be switched by the user 102 later. If the user 102 chooses to download the mobile application 110 to the mobile device, the user 102 may further select the make and model of the mobile device from a list of supported devices. There may be an additional check that the user's mobile device carrier will permit downloading of the mobile application 110. Similar selections and checks may be carried out for other interface options.

Next, at a step 512, the PayLink 112 generates a reference identifier, which the user 102 will use to activate the registered account. The reference identifier may be a short time duration reference identifier, requiring the user 102 to activate the account within a predetermined time period, for example 2 days.

Next, at a step 514, registration information is passed to the SCH 108 associated with the PayLink 112. The registration information may include: the PayLink account ID; the short time duration reference identifier; the user's telephone number; user preferences; unique tracking identifier; and/or make and model of the mobile device. The SCH 108 acknowledges receipt of the information and continues the remainder of the registration process with the appropriate user interface.

The timing of uploads from the PayLink 112 to the SCH 108 is based on definable criteria, for example upon full implementation of a PayLink 112, at the end of every business day, after every 250 new accounts, etc. Alternatively, in other embodiments new accounts may be uploaded instantaneously rather than in batches.

Next, at a step 516 the SCH 108 generates a user ID for the user 102, and at step 518 this user ID is mapped to the PayLink account ID. The user ID is at least unique within the SCH database 120, and may also be unique across multiple SCHs 108, though not necessarily. The mapping is stored in the SCH database 120. It is also noted in the SCH database 120 that the account has not been activated. The user ID and mapping is uploaded to the PRS 106 only after the user 102 activates the account, as described in the Account Activation section below. In the case of registration of a merchant server 104, account activation may not be required.

Before the user 102 can carry out transactions on the system 100, the user 102 must activate the account at a step 520, for example using a mobile device of the type selected at the step 510 where the user 102 has selected this interface option. This is described in the section on Account Activation below.

While the steps 514, 516, 518, and 520 have been described as occurring at the SCH 108, in some embodiments, the steps 514, 516, 518, and/or 520 may be implemented at the PayLink 112 and may occur at the PayLink 112 or jointly between the PayLink 112 and the SCH 108.

### Account Activation

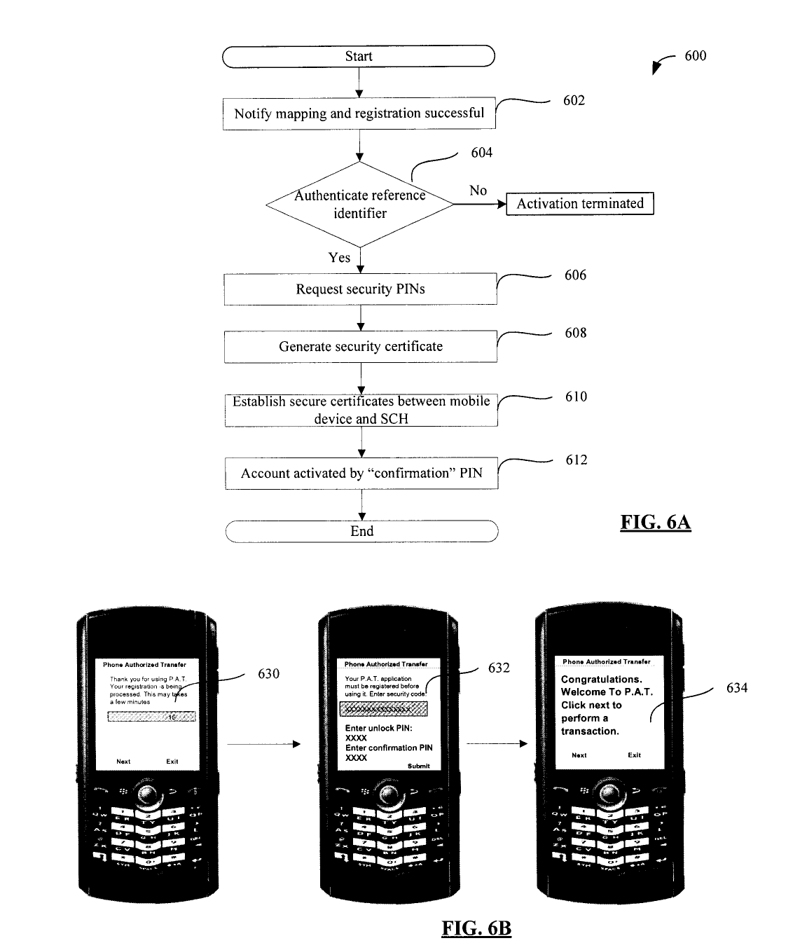

Reference is next made to FIG. 6A, which shows a flowchart illustrating a process 600 to activate a registered account in accordance with one embodiment of the present application. While the following description makes reference to the mobile device, it should be understood that similar operations may be carried out through other user interfaces, such as SMS and/or IVR-based interfaces.

At a step 602, the user 102 is notified that registration and mapping of user data was successful. This may be done by sending a text message from the SCH 108 to the user's mobile device (or in the second embodiment, from the PayLink 112 to the mobile device). The text message may include a link to the SCH 108 address embedded within the message, the link having a unique code to track the registration process. If the user 102 selected a mobile application 110 downloaded onto the mobile device as the preferred interface, then after the user 102 follows the link, the SCH 108 associated with the financial institution receives a request to download a copy of the mobile application 110 and returns the appropriate mobile application 110, in one example a MIDlet, after logging the tracking code. The mobile application 110 may contain the address of the SCH 108 associated with the financial institution and a copy of the security certificate of that SCH 108. In one embodiment, the mobile device negotiates the security certificate to be used with the mobile server 111, and downloads the mobile application 110 signed with the certificate of the mobile server 111.

Next, at a step 604, the user accesses the system 100 for the first time (for example, after installing the mobile application 110 and opening it for the first time) and is prompted for the reference identifier generated during registration. If this is incorrectly entered more than a predetermined number of times, for example five times, the reference identifier may be invalidated and the user 102 asked to contact the financial institution to re-register.

After authenticating the reference identifier, the user 102 is asked to enter user-selected PINs at a step 606. This includes an “unlock” PIN and a “confirmation” PIN. The “unlock” PIN may be used to encrypt data on the mobile application 110 and will be needed before the mobile application 110 is used in the future. This may provide an addition layer of security, for example in case the mobile device is lost or stolen. A hash code of the “confirmation” PIN is stored on the SCH 108 for verification of transactions. These PINs may be changed by the user 102 at any time. There may be additional security features associated with the PINs, such as the ability of the financial institution to invalidate the PIN after repeated incorrect entry. The financial institution may also be able to inactivate the user's PayLink account where the mobile device has been lost. The financial institution may also be able to erase any user data stored in the mobile device in encrypted form where security violations are suspected, requiring the user 102 to re-register.

Next, at a step 608, the mobile application 110 generates a Key Pair, and encrypts the private portion using the user's “unlock” PIN and stores it on the mobile device.

Next, at a step 610, the mobile application 110 opens a secure connection (for example, using HTTPS) to the mobile server 111. Verification of the mobile server certificate is carried out using known procedures. The mobile application 110 then provides its public key, the hash code of the “confirmation” PIN and the reference identifier to the mobile server 111. The mobile server 111 verifies the reference identifier against a list of outstanding unactivated accounts in the SCH database 120, signs the mobile application's public key, creating a certificate, and stores the hash code of the “confirmation” PIN. The signed certificate is then provided back to the mobile application 110 which encrypts it using the “unlock” PIN. Future communication between the mobile application 110 and the mobile server 111 can now be secured using the exchanged certificates.

Next, at a step 612, the user 102 again enters the “confirmation” PIN to activate the account. This is sent to the mobile server 111 which notifies the SCH 108 which marks the user's account as activated. The user ID to PayLink account ID mapping is uploaded to the PRS 106 to be stored in the PRS database 116. The account is now activated and the user 102 may carry out transactions on the system 100 using that account.

The next time the mobile server 111 is accessed by the user 102 for a transaction, the mobile server 111 will establish a secure connection (for example, HTTPS) to the financial institution's associated SCH 108. As will be understood by a person skilled in the art, the establishment of a secure connection includes the SCH 108 verifying the security certificate presented by the mobile server 111 as well as the mobile server 111 verifying the security certificate presented by the SCH 108, as is known in the field of network communication. Other security verification procedures or algorithms may be used.

While the steps 602, 604, 606, 608, 610, and 612 have been described as occurring at the SCH 108 or being primarily conducted by the SCH 108, in some embodiments, the steps 602, 604, 606, 608, 610, and 612 may be implemented by the PayLink 112 and may occur at the PayLink 112 or jointly between the PayLink 112 and the SCH 108.

Reference is next made to FIG. 6B, which shows an example of the user interface on a mobile device during account activation, in accordance with one embodiment of the present application.

A user interface 630 is presented to the user 102 at the step 604 while the user is being authenticated after opening the mobile application 110 for the first time.

Next, a user interface 632 is presented to the user 102 at the step 606, prompting the user 102 to enter an “unlock” PIN and a “confirmation” PIN.

Next, a user interface 634 is presented to the user 102 at the step 612, confirming that account activation was successful and allowing the user 102 to proceed with a transaction on the system 100.

While the processes 200, 300, 400, 500, 600 are described as being conducted serially or sequentially, it will be understood by those skilled in the art that many aspects of the processes may be conducted concurrently or in parallel. It will also be understood that many of the steps shown in the processes need not necessarily be executed in the shown order, and that variations in the method order may be implemented. While the processes 200, 300, 400, 500, and 600 have been described mainly with reference to the embodiment where the mobile server 111 connects with the service control host 108 through the communications network 114a, it will be understood that in the embodiment where the mobile server 111 connects with the PayLink 112 through the communications network 114a, some of the steps shown in the described processes may occur in a different order or other details pertaining to the described interaction of the components of the system 100 may vary accordingly.

### Example Uses

There are many potential uses for the system and method disclosed in the present application. In one example, the system and method may be used for interactions and purchases found in m-commerce, which may be more convenient than using alternative means of payment. For example, some purchases are inconvenient to perform at certain points in time by other means, such as when the user is away from home or away from a bank. This may include impulse purchases of convenience, such as mobile phone top-up, purchases of cinema tickets, or payment of highway tolls.

### Mobile Phone Top-up

In markets with a preponderance of pre-paid mobile phone accounts, there is a need to quickly top up phone accounts. Using the disclosed system and method, the user may access the carrier's top up account number (e.g., a phone number identifier) to quickly identify the purchase. The user then simply enters the amount to top up and the confirmation of purchase to have the phone account topped up.

Prepaid accounts are often used by children whose parents wish to control their spending. By allowing the user to enter the number of the phone to top up, parents can quickly top up a child's account on the go.

### Cinema Tickets

The purchase of cinema tickets is frequently an impulse purchase, which is suitably handled by the disclosed system and method. A user may be enticed by a poster to see a film, and the user may immediately use the phone number displayed on the poster for cinemas in the area to inquire when the show times are and to buy tickets using a credit card. The user may claim the tickets by presenting the credit card at the theatre. This is a variant of existing online ticket purchasing systems, and the disclosed system may easily interface into the existing system.

### Toll Highways

Express toll highways often require stopping at a physical location or paying the charge online before entering onto the highway. Alternatively, some toll highways use license plate identification technology to send invoices in the mail, typically with an added premium. Drivers may not be aware of the charge or their need to use the highway beforehand, eliminating the option of prepaying. Using the disclosed system and method, the driver could simply select the charging authority by keying in the respective telephone number, the date of payment and enter the licence number of the car. The payment would be made immediately without the need to visit a physical location or to access a wired internet connection.

In accordance with other embodiments, the user interface on the mobile device may be implemented by an IVR application, an SMS application, or a computer-implemented user interface such as a Web-based user interface, depending on the capabilities of the mobile device. Although the description refers to phone numbers or user names as the method of identifying the user and merchant, other identifiers, such as a domain address, may be used.

The user may initiate registration in the system 100 through an online banking service, through a telephone banking service, in person at the financial institution or via any other interaction where the customer initiating the registration can be sufficiently authenticated.

While the description has been given for associating the user with a single set of payment data, such as a single credit card from a single bank, the disclosed system may include embodiments where the user is registered with multiple credit cards from multiple banks or multiple credit cards from a single bank. In one embodiment, the user is limited to registering multiple credit cards from multiple banks only where the multiple banks all communicate with the same SCH. The user may be prompted to select the desired credit card at the beginning of a transaction, or at a payment request.

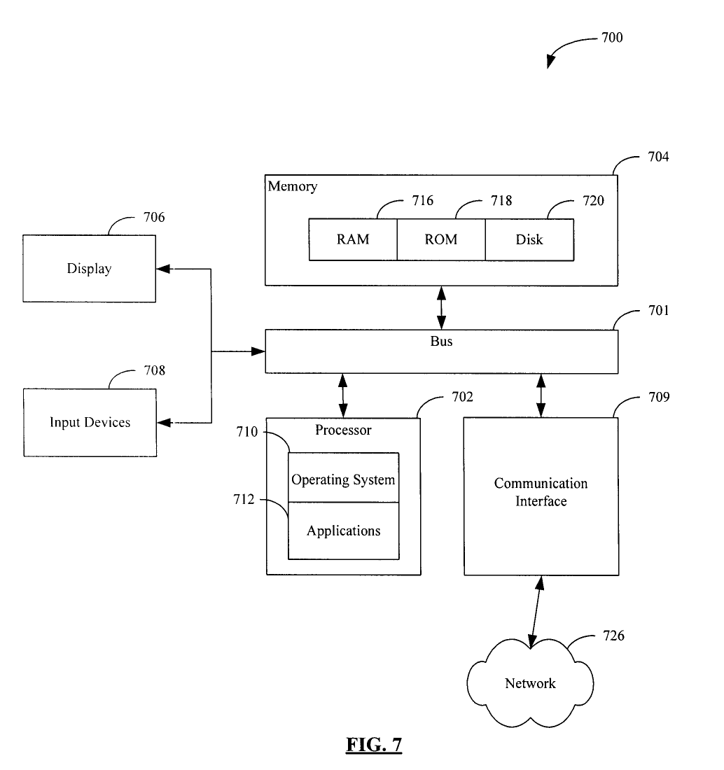

Reference is next made to FIG. 7, which shows a computing device architecture 700 that may be used with the system 100 shown in FIG. 1. The computing device architecture 700 may be representative of the mobile device or any of the computing devices, servers, or computers described above. The computing device 700 generally comprises a bus 701, a processor 702, a memory 704, a display 706, user input devices 708, and a communication interface 709, which may all be coupled to the bus 701. In one example, the user input devices 708 are a keyboard or pointing device such as a mouse. The communication interface 709 provides an interface for communicating with a network 726. An operating system 710 or applications 712 run on the processor 702. The memory 704 includes Random Access Memory (RAM) 716, Read Only Memory (ROM) 718, and a disk 720. In one example, the data processing system 700 comprises either a client or a server. Any of the software modules or components mentioned above may be stored in the memory 704 for execution by the processor 702.

While aspects of this application are primarily discussed as a method, persons of ordinary skill in the art would understand that the systems described above may be programmed and configured to enable the methods of the application to be practised. Moreover, articles of manufacture for use with the systems, such as a pre-recorded storage device or other machine or computer readable medium including program instructions recorded thereon may direct the systems to facilitate the practise of the methods of the application. It is understood that such systems and articles of manufacture also come within the scope of the application.

The embodiments of the present application described above are intended to be examples only. Those skilled in the art may effect alterations, modifications and variations to the particular embodiments without departing from the scope of the present application. In particular, selected features from one or more of the above-described embodiments may be combined to create alternative embodiments not explicitly described, features suitable for such combinations being readily apparent to persons skilled in the art. The subject matter described herein in the recited claims intends to cover and embrace all suitable changes in technology.

1. A system for communicating with a merchant server and transferring payment data in a transaction between a mobile device and the merchant server, a user of the mobile device having a user identifier registered with the system and the merchant server having a merchant identifier registered with the system, the system comprising:
a mobile device gateway server comprising a processor operatively connected to a memory, the memory having data and instructions stored thereon to configure the mobile device gateway server to interface with the mobile device and to interface with other components of the system to:
receive the merchant identifier from the mobile device;
determine a merchant server address associated with the merchant identifier;
establish a secure communication channel with the merchant server;
transfer a payment data request from the merchant server to the mobile device;
transfer a payment request response from the mobile device to the merchant server;
determine payment data associated with the user identifier; and
provide the payment data to the merchant server.

2. The system according to claim 1, wherein the mobile device gateway is further configured to interface with the mobile device and to interface with other components of the system to, after establishing a communication channel:
transfer an interactive information request from the merchant server to the mobile device; and
transfer an information request response from the mobile device to the merchant server.

3. The system according to claim 2, wherein the interactive information request includes an interactive query script to be executed by the mobile device.

4. The system according to claim 3, wherein the interactive query script is an XML script.

5. The system according to claim 1, wherein the mobile device gateway server is further configured to interface with the mobile device and to interface with other components of the system to, before the step of receiving the merchant identifier:
authenticate a user of the mobile device; and
determine the unique user identifier associated with the authenticated user.

6. The system according to claim 1, wherein the mobile device gateway server is further configured to interface with the mobile device and to interface with other components of the system to, after establishing a secure communication channel with the merchant server:
authenticate the merchant server.

7. The system according to claim 1, wherein the mobile device gateway server is further configured to interface with the mobile device and to interface with other components of the system to, after providing the payment data to the merchant server:
provide a transaction confirmation to the mobile device if the transaction is successfully processed by the merchant server.

8. The system according to claim 1, wherein the system further comprises:
a service control host server connected to the mobile device gateway server through a first network, the service control host server also being connected to the merchant server through a second network; and
a bank server connected to the service control host server through a third network.

9. The system according to claim 1, wherein the system further comprises:
a bank server connected to the mobile device gateway server through a first network, and
a service control host server connected to the bank server through a second network, the service control host server being connected to the merchant server through a third network.

10. A method for use in payment a system for communicating with a merchant server and transferring payment data in a transaction between a mobile device and the merchant server, a user of the mobile device having a registered user identifier and the merchant having a registered merchant identifier, the method comprising:
receiving the merchant identifier from the mobile device;
determining a merchant server address associated with the merchant identifier;
establishing a communication channel with the merchant server;
transferring a transfer of payment data request from the merchant server to the mobile device;
transferring a payment request response from the mobile device to the merchant server;
determining payment data associated with the user identifier; and
providing the payment data to the merchant server.

11. The method according to claim 10, further comprising, after establishing a communication channel with the merchant server:
transferring an interactive information request from the merchant server to the mobile device and
transferring an information request response from the mobile device to the merchant server.

12. The method according to claim 11, wherein the interactive information request includes an interactive query script to be executed by the mobile device.

13. The method according to claim 12, wherein the interactive query script is an XML script.

14. The method according to claim 10, wherein the method further comprises, before receiving the merchant identifier:
authenticating a user of the mobile device; and
determining the unique user identifier associated with the authenticated user.

15. The method according to claim 10, wherein the method further comprises, after establishing a secure communication channel with the merchant server:
authenticating the merchant server.

16. The method according to claim 10, wherein the method further comprises, after providing the payment data to the merchant server:
providing a transaction confirmation to the mobile device if the transaction is successfully processed by the merchant server.

17. A method of registering a user in a payment system, the payment system for communicating with a merchant server and transferring payment data in a transaction between a mobile device and the merchant server, the method comprising:
receiving a request for registration of an account;
receiving payment data associated with the user;
generating an account identification (ID) and mapping the account ID to the payment data; and
storing the account ID, the mapping and the associated data in a database.

18. The method according to claim 17, further comprising:
receiving a user interface preference for the mobile device; and
sending to the mobile device a mobile application according to the received interface preference.

19. The method according to claim 18, further comprising:
generating a reference identifier for use to activate the registered account;
generating a user idenitifcation associated with the account ID;
mapping the account ID to the user identification and storing the mapping in a further database; and
activating the registered account by communicating with the mobile device.

20. The method according to claim 19, wherein activating the registered account by communicating with the mobile device comprises:
notifying the mobile device that registration was successful, the notification including an address of a server to complete activation;
authenticating the reference identifier generated during registration;
authenticating a personal identification number;
generating at the mobile application a key pair, encrypting a private portion of the key pair and storing it on the mobile device; and
opening a secure connection between the mobile device and a mobile server and generating and storing on each of the mobile device and the mobile server security certificates for use in future communications sessions between the mobile device and the mobile server
